(19) United States
(12) Patent Application Publication
(10) Pub. No.: US 2006/0152032 A1
(43) Pub. Date: Jul. 13, 2006

(54) Convertible vehicle

(76) Inventor: Eduard Jurgens, BAD IBURG (DE)

Correspondence Address: FRIEDRICH KUEFFNER, 317 MADISON AVENUE, SUITE 910, NEW YORK, NY, 10017, US

(21) Appl. No.: 10/535,650

(22) PCT Filed: Nov. 18, 2003
(86) PCT No.: PCT/DE03/03814

§ 371 Date: Feb. 13, 2006

(51) Int. Cl. B60J 7/14

(52) U.S. Cl. 296/107.01

(57) ABSTRACT

Disclosed is a convertible vehicle (1) comprising a roof (2) that encompasses at least two parts (3; 4) which are provided with a number of areas. Said convertible vehicle is embodied such that the areas are formed by individual, separate exterior pieces (8; 9) that can be indirectly or directly connected to a supporting structure (10) of the roof parts (3; 4).

The invention concerns a motor vehicle with a collapsible roof in accordance with the introductory clause of Claim 1 and in accordance with the introductory clause of Claim 10.

Convertible roofs made, for example, of rigid metal parts can be painted with the same color as the automobile, i.e., with the color with which the automobile body is painted. Since the roofs can be installed only after completion of the painting, the body shells and the roof parts are individually and successively conveyed through the painting line. This takes more time per vehicle compared to a closed vehicle, so that the line production rate is reduced by the painting line. Due to the shape of the roof, the painting time for the roof is often of the same order of magnitude as the painting time for the body shell.

The invention is based on the problem of improving this situation.

The invention solves this problem with a convertible vehicle with the features of Claim 1 and with a roof with the features of Claim 10. Advantageous modifications of the invention are specified in the dependent Claims 2 to 9 and 11.

The convertible vehicle of the invention in accordance with Claim 1 makes it possible to achieve increased effectiveness in the painting line, since it is no longer necessary to paint complete roofs. The exterior parts to be painted have a considerably smaller area to be painted compared to complete roofs, so that they can be painted faster. In addition, the structure of the exterior parts is very simple, which further assists the painting process.

In the design in accordance with Claim 10, it is also possible to use completely unpainted exterior parts to cover lateral regions of the roof, for example, even plastic parts produced from recycled granulated plastic or transparent glass or other plastic parts.

The weight of the roof can be reduced by the use of light construction materials, especially plastics, for the exterior parts.

If the exterior parts are detachably connected with the roof structure, a simple replacement of exterior parts is possible even after some period of use, including, for example, for the purpose of installing parts of a different color.

It is advantageous to mount the exterior parts on a roof that is otherwise already completely installed. The mounting can be accomplished in an especially simple way with a releasable mechanical connection, for example, a clip connection, which serves at least as a positioning aid, possibly supported by additional adhesive bonding.

Additional advantages and features of the invention are described below with reference to a specific embodiment of the object of the invention, which is illustrated in the drawings.

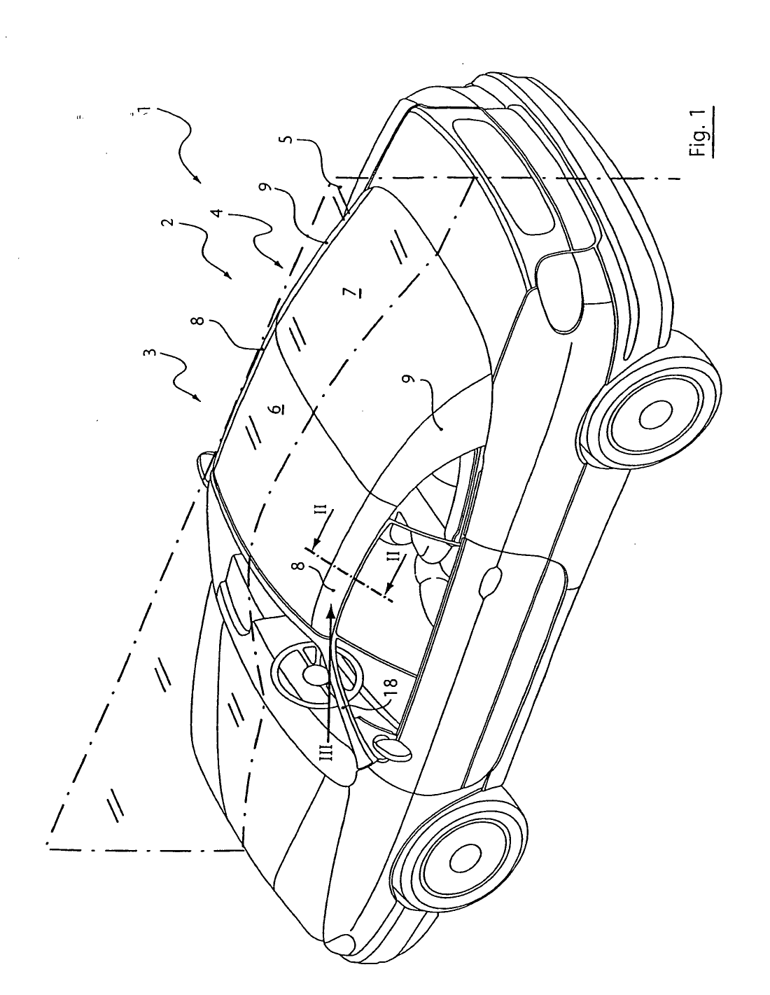

FIG. 1 shows a schematic overall view of a convertible vehicle of the invention with glass sections located in the roof between the painted exterior parts and with the roof closed.

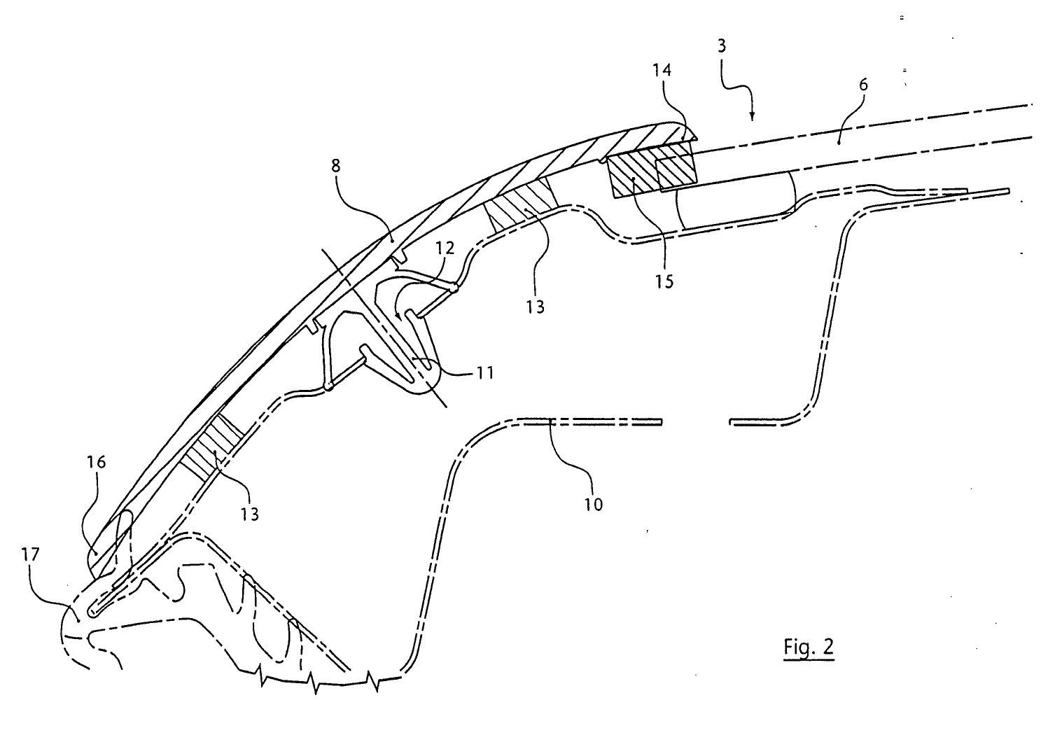

FIG. 2 shows a section along line II-II in FIG. 1.

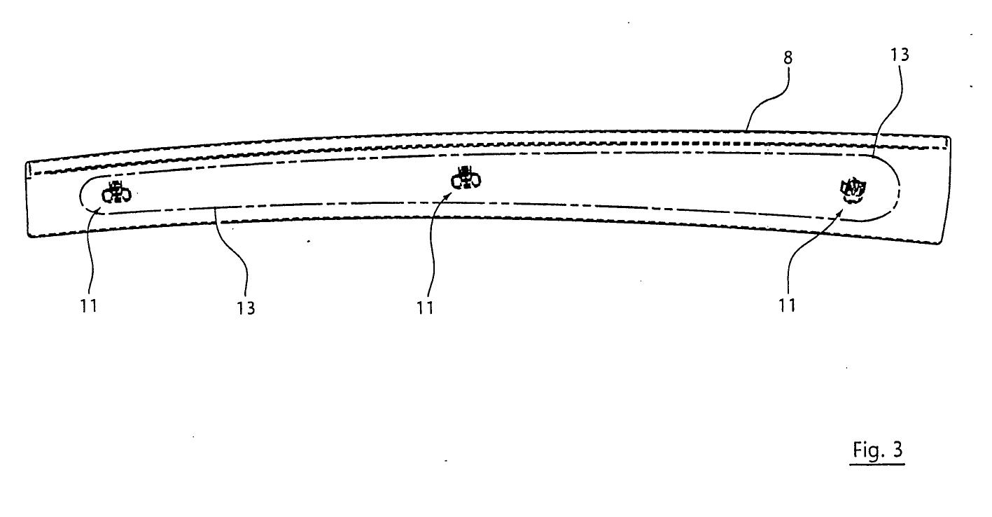

FIG. 3 shows a view in the direction of the longitudinal center plane of the vehicle towards an exterior part, which is assumed to be transparent here for better illustration, and its attachment, corresponding approximately to a view from the direction of the arrow III in FIG. 1.

The illustrated convertible vehicle 1 has a collapsible roof 2, which in the present embodiment has a front roof part 3 and a rear roof part 4. Division of the roof into more than two roof parts is also possible.

The roof parts 3, 4 are designed symmetrically with respect to a vertical longitudinal center plane 5 and have glass surfaces in their middle sections with respect to this plane 5. The front roof part 3 has middle section 6, and the rear roof part 4 has middle section 7. A different configuration is also possible, for example, a configuration in which the middle sections are designed similarly to the lateral sections and have detachable painted parts. A textile covering of the middle sections is also conceivable.

Individually mountable exterior parts 8, 9 are assigned to the longitudinal sides of the vehicle on each roof part 3, 4. These exterior parts are placed as longitudinal planks on lateral frames 10, e.g., hollow sections, which support the roof 2, and are directly or indirectly connected with the frames 10. The exterior parts 8, 9 themselves have no supporting function, and it is advantageous for the purpose of weight reduction for them to be made of a light construction material, for example, plastic, light metal, or a metallic foam material.

In the present embodiment, the exterior parts are made of plastic and are produced by injection molding, for example, as single pieces or, as in the present case, in several pieces, with clip attachments 11, by which they can be pressed into recesses 12 in the roof frame 10 and locked in place. Both an undetachable connection and a detachable connection between the exterior parts 8, 9 and the roof frame 10 are possible. In the present embodiment, several clip attachments 11 are provided in a longitudinal row for each exterior part 8, 9.

In the present embodiment, in addition to the clip connection 11, 12, a bead of adhesive 13 is provided, which can be applied to the roof frame 10 by a robot and encircles the recesses 12 into which the clip connections 11 fit. The exterior parts 8, 9 are reliably positioned on the lateral frame 10 by pressing the clips 11 into the recesses 12. At the same time, this presses the exterior parts 8, 9 against the bead of adhesive 13, which ensures the transmission of forces. On the edges 14 that face the longitudinal center plane 5, the exterior parts 8, 9 are pressed onto the middle section 6 or 7 via a spacing gasket 15. In this regard, the pressure can be produced by the tension in the material of the exterior parts 8, 9 without additional fastening means. In this case, access to the adhesive 13 can also be obtained by bending the edge 14 upward, and the adhesive can then later be removed, if necessary. A similar situation exists at the vehicle outer edge 16 of the exterior parts 8, 9: here too, the edge 16 rests under spring tension on a gasket 17, which is supported on the frame part 10. The edge 16 can be bent upward in the same way to allow replacement of the exterior parts 8, 9.

In this regard, it is possible, for example, to exchange exterior parts 8, 9 in the color of the automobile for exterior parts in a contrast color. In addition to an assortment of exterior parts 8, 9 with different colors, it is also possible to design exterior parts with slightly varying shapes, for example, smooth-surfaced, more graceful exterior parts 8, 9, on the one hand, and sportier exterior parts 8, 9 with a streamlining function, on the other hand. Unpainted exterior parts 8, 9 made, for example, from recycled materials, are also conceivable for an inexpensive basic model. Transparent exterior parts 8, 9 can also be used. All together, this results in considerably greater freedom of design for the designers.

During production, the exterior parts 8, 9, if they are to be painted, can simply be moved with the automobile body through the painting line due to their compact form. It is merely a matter of uniform painting of the outside surfaces, for there are no large undercuts, cavities, edges or the like. The total surface area of the roof 2 to be painted to match the automobile body is thus minimized. With an arrangement of exterior parts 8, 9 of this type on both the front roof part 3 and the rear roof part 4, combined with a painted windshield frame 18, it is possible to achieve a lateral roof edge that is comparable in quality, with respect to both color and the appearance of an integrated structure, to that of a roof that is totally painted together with the automobile body.

The painting of only individual exterior parts 8, 9 of the roof parts 3, 4 or contrast painting of the exterior parts 8, 9 is also possible, depending on design requirements.

1. Convertible vehicle (1) with a roof (2) with at least two parts (3, 4), which have painted areas, especially to match the color of the automobile body, wherein painted areas are formed by individual, separate exterior parts (8, 9) that can be directly or indirectly attached to a supporting structure (10).

2. Convertible vehicle in accordance with claim 1, wherein the exterior parts (8, 9) are made of a light construction material.

3. Convertible vehicle in accordance with claim 1, wherein the exterior parts (8, 9) are made of plastic.

4. Convertible vehicle in accordance with claim 1, wherein the exterior parts (8, 9) can be detachably connected to the roof structure (10).

5. Convertible vehicle in accordance with claim 1, wherein the exterior parts (8, 9) can be mechanically connected to the roof structure (10).

6. Convertible vehicle in accordance with claim 5, wherein the exterior parts (8, 9) can be connected to the roof structure (10) by clips.

7. Convertible vehicle in accordance with claim 1, wherein the exterior parts (8, 9) can be adhesively bonded to the roof structure (10).

8. Convertible vehicle in accordance with claim 1, wherein the exterior parts (8, 9) extend along lateral longitudinal edges of the roof parts (3, 4), and transparent panels are provided in a section (6, 7) located in the middle with respect to a vertical longitudinal center plane (5) of the vehicle.

9. Convertible vehicle in accordance with claim 1, wherein an assortment of exterior parts (8, 9) can be provided and mounted on the otherwise finished roof (2).

10. Convertible vehicle in accordance with claim 1, wherein the exterior parts (8, 9) of the assortment have different colors and/or shapes.

10. (canceled)

11. (canceled)

12. Convertible vehicle (1) with a roof (2) with at least two parts (3, 4), which have areas that cover the roof frame on lateral outer edges, especially in accordance with claim 1, wherein the covering areas are formed by individual, separate exterior parts (8, 9) that can be directly or indirectly attached to a supporting structure (10).

13. Roof (2) for a convertible vehicle (1) in accordance with claim 1.
